(19) United States
(12) Patent Application Publication
(10) Pub. No.: US 2017/0243690 A1
(43) Pub. Date: Aug. 24, 2017

(54) COMPOSITE INDUCTOR STRUCTURE

(71) Applicant: MEDIATEK INC., Hsin-Chu (TW)

(72) Inventors: Huan-Sheng Chen, Tainan City (TW); Yan-Bin Luo, Taipei City (TW)

(21) Appl. No.: 15/186,554

(22) Filed: Jun. 20, 2016

Related U.S. Application Data
(60) Provisional application No. 62/297,998, filed on Feb. 22, 2016.

(51) Int. Cl. H01F 27/28

(52) U.S. Cl. CPC H01F 27/2804

(57) ABSTRACT

A composite inductor structure is provided, which comprises: a first spiral inductor and a second spiral inductor. The first spiral inductor has a plurality of loops and generates a first electromagnetic field, wherein an outermost loop of the first spiral inductor has a first end point, and an innermost loop of the first spiral inductor has a second end point. The second spiral inductor is arranged to be adjacent to the first spiral inductor, and has a plurality of loops and generates a second electromagnetic field, wherein an outermost loop of the second spiral inductor has a third end point, and an innermost loop of the second spiral inductor has a fourth end point, and the second spiral inductor is rotated by a specific degree with respect to an orientation of the first spiral inductor, and the first electromagnetic field and the second electromagnetic field are oppositely directed.

### CROSS REFERENCE TO RELATED APPLICATIONS

This application claims the benefit of U.S. Provisional Application No. 62/297,998, filed on Feb. 22, 2016 and included herein by reference.

### BACKGROUND

The present invention relates to a composite inductor structure, and more particularly, to a miniaturized low parasitic magnetic coupling spiral inductor structure.

Please refer to FIG. 1. FIG. 1 shows a simplified block diagram of a conventional twisted inductor structure 100, wherein the conventional twisted inductor structure 100 generates two opposite magnetic fields. As shown in FIG. 1, the conventional twisted inductor structure 100 comprises: a first inductor 110 and a second inductor 120, wherein the first inductor 110 has a first end point 112 and a second end point 114, and the second inductor 120 has a third end point 122 and a fourth end point 124. An inter-connection of the first inductor 110 and the second inductor 120 is connected between the second end point 114 and the fourth end point 124, and the conventional twisted inductor structure 100 has a short inter-connection. However, the first inductor 110 has weak magnetic coupling with the second inductor 120, and the conventional twisted inductor structure 100 usually needs a large area since its mutual coupling is not well exploited. In addition, when the conventional twisted inductor structure 100 is coupled to a circuit 130, the electromagnetic fields generated by the conventional twisted inductor structure 100 are imbalance (i.e. not equal) for the circuit 130 (i.e. other components).

Please refer to FIG. 2a. FIG. 2a is a simplified diagram of a conventional spiral inductor structure 200. As shown in FIG. 2a, the conventional spiral inductor structure 200 comprises: a first spiral inductor 210 and a second spiral inductor 220, wherein the first spiral inductor 210 and the second spiral inductor 220 are disposed on a same layer. The first spiral inductor 210 has two loops and generates a first electromagnetic field, wherein mutual coupling between the loops of the first spiral inductor 210 is well exploited in a smaller area in comparison with the prior art shown in FIG. 1, and an outermost loop of the first spiral inductor 210 has a first end point 212, and an innermost loop of the first spiral inductor 210 has a second end point 214. The second spiral inductor 220 is identical to the first spiral inductor 210, and is arranged to be adjacent to the first spiral inductor 210, and two loops and generates a second electromagnetic field, wherein mutual coupling between the loops of the second spiral inductor 220 is also well exploited in a smaller area in comparison with the prior art shown in FIG. 1, and an outermost loop of the second spiral inductor 220 has a third end point 222, and an innermost loop of the second spiral inductor 220 has a fourth end point 224. However, the conventional spiral inductor structure 200 has a long and imbalance inter-connection since the inter-connection of the first spiral inductor 210 and the second spiral inductor 220 is connected between the second end point 214 and the fourth end point 224. In addition, when the conventional spiral inductor structure 200 is coupled to a circuit 230, the first electromagnetic field generated by the first spiral inductor 210 and the second electromagnetic field generated by the second spiral inductor 220 are imbalance (i.e. not equal) for the circuit 230 (i.e. other components).

Please refer to FIG. 2b. FIG. 2b is a another simplified diagram of the conventional spiral inductor structure 200. As shown in FIG. 2b, when the conventional spiral inductor structure 200 is coupled to the circuit 230 in another way, the first electromagnetic field generated by the first spiral inductor 210 and the second electromagnetic field generated by the second spiral inductor 220 are balance (i.e. equal) for the circuit 230. However, the conventional spiral inductor structure 200 still has a long and imbalance inter-connection since the inter-connection of the first spiral inductor 210 and the second spiral inductor 220 is connected between the second end point 214 and the fourth end point 224. In addition, when the conventional spiral inductor structure 200 is coupled to a circuit 230 in this way, the first spiral inductor 210 and the second spiral inductor 220 have an unequal and imbalance lead length.

### SUMMARY

It is therefore one of the objectives of the disclosure to provide a composite inductor structure having lower parasitic coupling and well exploited mutual coupling in a smaller area, and a shorter and balance inter-connection, and an equal and balance lead length, so as to solve the problem mentioned above.

In accordance with an embodiment of the present invention, a composite inductor structure is disclosed. The composite inductor structure comprises: a first spiral inductor and a second spiral inductor. The first spiral inductor has a plurality of loops and generates a first electromagnetic field, wherein an outermost loop of the first spiral inductor has a first end point, and an innermost loop of the first spiral inductor has a second end point. The second spiral inductor is arranged to be adjacent to the first spiral inductor, and has a plurality of loops and generates a second electromagnetic field, wherein an outermost loop of the second spiral inductor has a third end point, and an innermost loop of the second spiral inductor has a fourth end point, and the second spiral inductor is rotated by a specific degree with respect to an orientation of the first spiral inductor, and the first electromagnetic field and the second electromagnetic field are oppositely directed.

Briefly summarized, the composite inductor structure disclosed by the present invention has lower parasitic coupling and well exploited mutual coupling in a smaller area, and a shorter and balance inter-connection, and an equal and balance lead length.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 shows a simplified block diagram of a conventional twisted inductor structure.

FIG. 2a is a simplified diagram of a conventional spiral inductor structure.

FIG. 2b is a another simplified diagram of the conventional spiral inductor structure.

FIG. 3 is a simplified diagram of a composite inductor structure in accordance with a first embodiment of the present invention.

FIG. 4 is a simplified diagram of a composite inductor structure in accordance with a second embodiment of the present invention.

FIG. 5 is a simplified diagram of a composite inductor structure in accordance with a third embodiment of the present invention.

### DETAILED DESCRIPTION

Certain terms are used throughout the description and following claims to refer to particular components. As one skilled in the art will appreciate, manufacturers may refer to a component by different names. This document does not intend point to distinguish between components that differ in name but not function. In the following description and in the claims, the terms “include” and “comprise” are used in an open-end pointed fashion, and thus should be interpreted to mean “include, but not limited to”. Also, the term “couple” is intend pointed to mean either an indirect or direct electrical connection. Accordingly, if one device is coupled to another device, that connection may be through a direct electrical connection, or through an indirect electrical connection via other devices and connections.

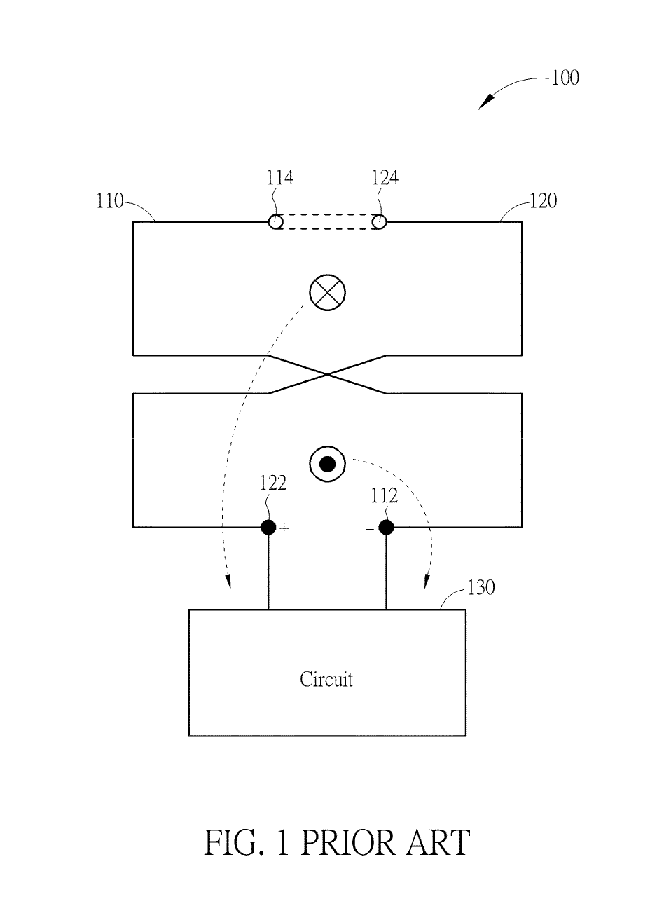

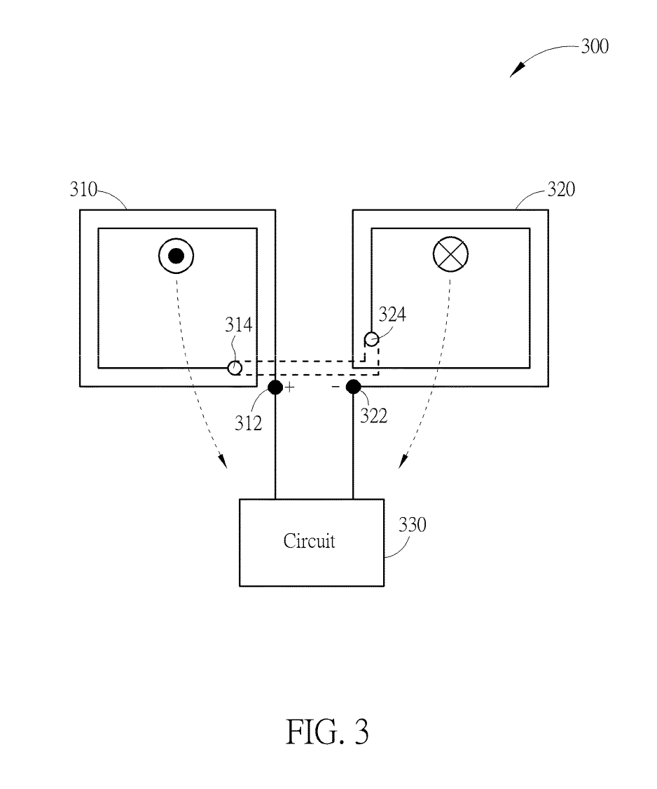

Please refer to FIG. 3. FIG. 3 is a simplified diagram of a composite inductor structure 300 in accordance with a first embodiment of the present invention, wherein the composite inductor structure 300 can be applied to an integrated circuit (IC). As shown in FIG. 3, the composite inductor structure 300 comprises: a first spiral inductor 310 and a second spiral inductor 320, wherein the first spiral inductor 310 and the second spiral inductor 320 are disposed on a same layer. The first spiral inductor 310 has two loops and generates a first electromagnetic field, wherein mutual coupling between the loops of the first spiral inductor 310 is well exploited in a smaller area in comparison with the prior art shown in FIG. 1, and an outermost loop of the first spiral inductor 310 has a first end point 312, and an innermost loop of the first spiral inductor 310 has a second end point 314. The second spiral inductor 320 is arranged to be adjacent to the first spiral inductor 310, and has two loops and generates a second electromagnetic field, wherein mutual coupling between the loops of the second spiral inductor 320 is also well exploited in a smaller area in comparison with the prior art shown in FIG. 1, and an outermost loop of the second spiral inductor 320 has a third end point 322, and an innermost loop of the second spiral inductor 320 has a fourth end point 324. The second spiral inductor 320 is rotated by 90 degree with respect to an orientation of the first spiral inductor 310, and the first electromagnetic field and the second electromagnetic field are oppositely directed. In addition, the first spiral inductor 310 and the second spiral inductor 320 are the same spiral inductors if second spiral inductor 320 is rotated by 0 degree or 360 degree with respect to an orientation of the first spiral inductor 310.

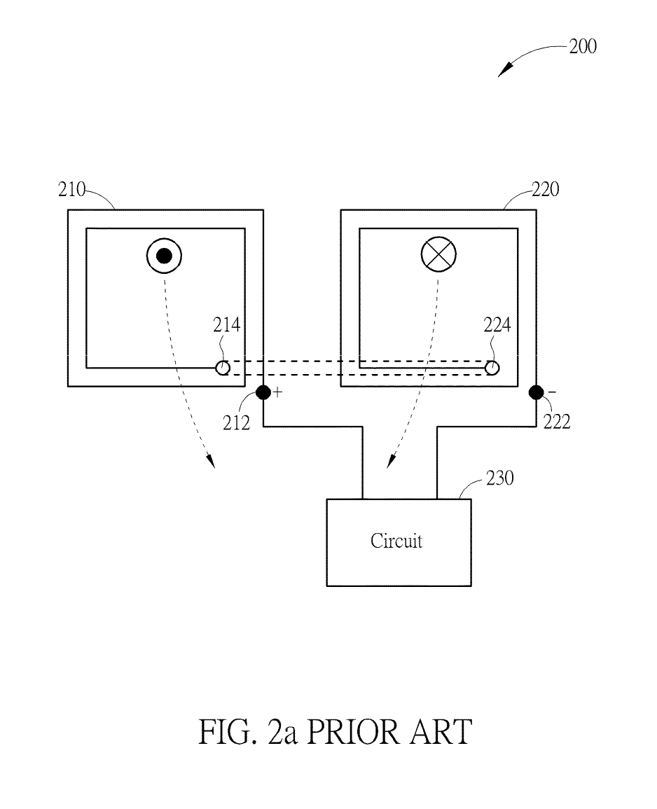

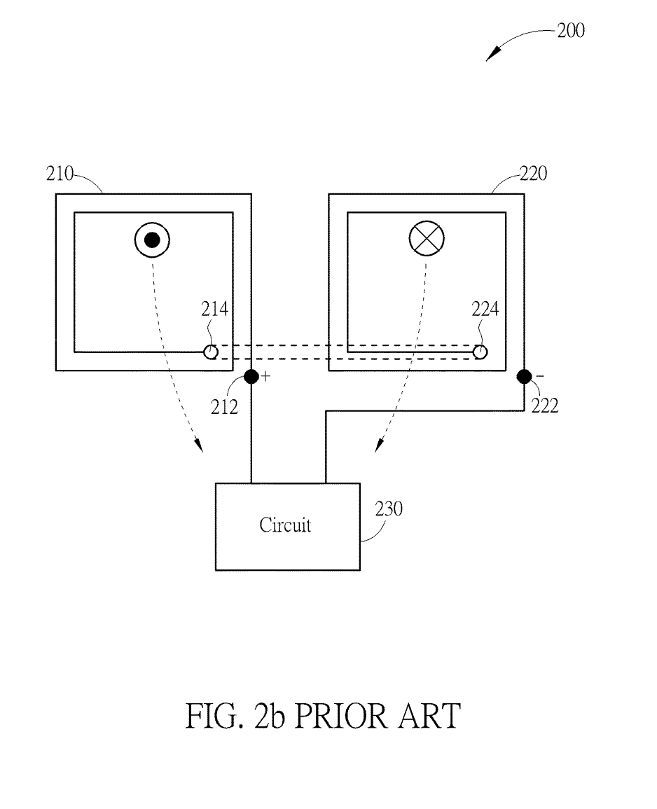

The first spiral inductor 310 and the second spiral inductor 320 have an equal and balance lead length when the first spiral inductor 310 and the second spiral inductor 320 are coupled to a circuit 330, wherein the first end point 312 of the first spiral inductor 310 and the third endpoint 322 of the second spiral inductor 320 are coupled to the circuit 330. The first electromagnetic field and the second electromagnetic field are equal and opposite magnetic fields for the circuit 300, and thus the composite inductor structure 300 has a lower parasitic coupling to the circuit 330 (i.e. other components) in comparison with the prior art shown in FIG. 1. In addition, an inter-connection of the first spiral inductor 310 and the second spiral inductor 320 is connected between the second end point 314 and the fourth end point 324, and thus the composite inductor structure 300 has a shorter and balance inter-connection in comparison with the prior art shown in FIG. 2a and FIG. 2b. Please note that the above embodiment is only for an illustrative purpose and are not meant to be a limitation of the present invention. For example, the number of loops of the first spiral inductor 310 and the second spiral inductor 320 can be changed according to different design requirements, or the second spiral inductor 320 can be rotated by 180 degree with respect to an orientation of the first spiral inductor 310 according to different design requirements. In addition, the shape of the first spiral inductor 310 and the second spiral inductor 320 also can be changed (for example, circle or other polygon types) according to different design requirements.

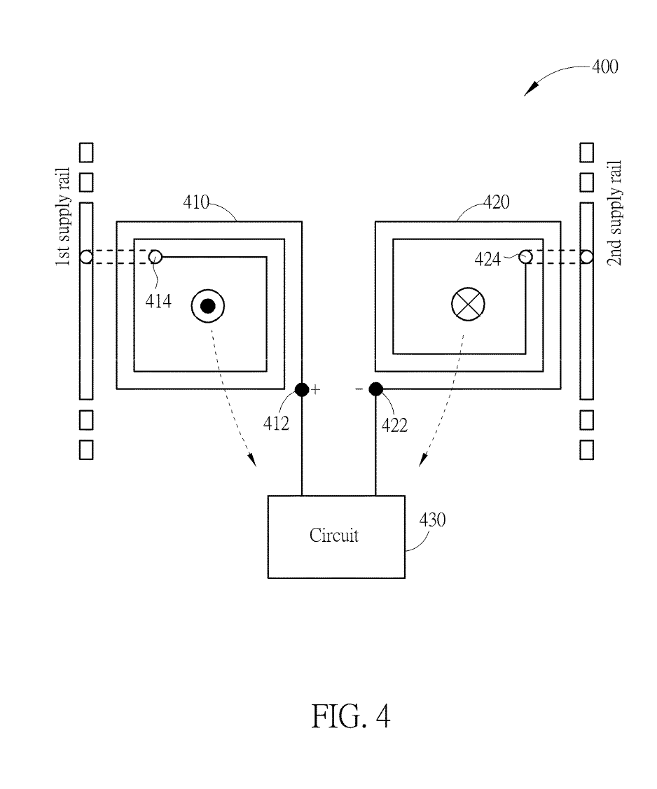

Please refer to FIG. 4. FIG. 4 is a simplified diagram of a composite inductor structure 400 in accordance with a second embodiment of the present invention, wherein the composite inductor structure 400 can be applied to an IC. As shown in FIG. 4, the composite inductor structure 400 comprises: a first spiral inductor 410 and a second spiral inductor 420, wherein the first spiral inductor 410 and the second spiral inductor 420 are disposed on a same layer. The first spiral inductor 410 has three loops and generates a first electromagnetic field, wherein mutual coupling between the loops of the first spiral inductor 410 is well exploited in a smaller area in comparison with the prior art shown in FIG. 1, and an outermost loop of the first spiral inductor 410 has a first end point 412, and an innermost loop of the first spiral inductor 410 has a second end point 414. The second spiral inductor 420 is arranged to be adjacent to the first spiral inductor 410, and has three loops and generates a second electromagnetic field, wherein mutual coupling between the loops of the second spiral inductor 420 is also well exploited in a smaller area in comparison with the prior art shown in FIG. 1, and an outermost loop of the second spiral inductor 420 has a third end point 422, and an innermost loop of the second spiral inductor 420 has a fourth end point 424. The second spiral inductor 420 is rotated by 90 degree with respect to an orientation of the first spiral inductor 410, and the first electromagnetic field and the second electromagnetic field are oppositely directed. In addition, the first spiral inductor 410 and the second spiral inductor 420 are the same spiral inductors if second spiral inductor 420 is rotated by 0 degree or 360 degree with respect to an orientation of the first spiral inductor 410.

The first spiral inductor 410 and the second spiral inductor 420 have an equal and balance lead length when the first spiral inductor 410 and the second spiral inductor 420 are coupled to a circuit 430, wherein the first end point 412 of the first spiral inductor 410 and the third end point 422 of the second spiral inductor 420 are coupled to the circuit 430. The first electromagnetic field and the second electromagnetic field are equal and opposite magnetic fields for the circuit 430, and thus the composite inductor structure 400 has a lower parasitic coupling to the circuit 430 (i.e. other components) in comparison with the prior art shown in FIG. 1. In addition, the second end point 414 is coupled to a first supply rail and the fourth end point 424 is coupled to a second supply rail, and thus the composite inductor structure 400 has a shorter and balance inter-connection in comparison with the prior art shown in FIG. 2a and FIG. 2b. Please note that the above embodiment is only for an illustrative purpose and are not meant to be a limitation of the present invention. For example, the number of loops of the first spiral inductor 410 and the second spiral inductor 420 can be changed according to different design requirements, or the second spiral inductor 420 can be rotated by 180 degree with respect to an orientation of the first spiral inductor 410 according to different design requirements. In addition, the shape of the first spiral inductor 410 and the second spiral inductor 420 also can be changed (for example, circle or other polygon types) according to different design requirements.

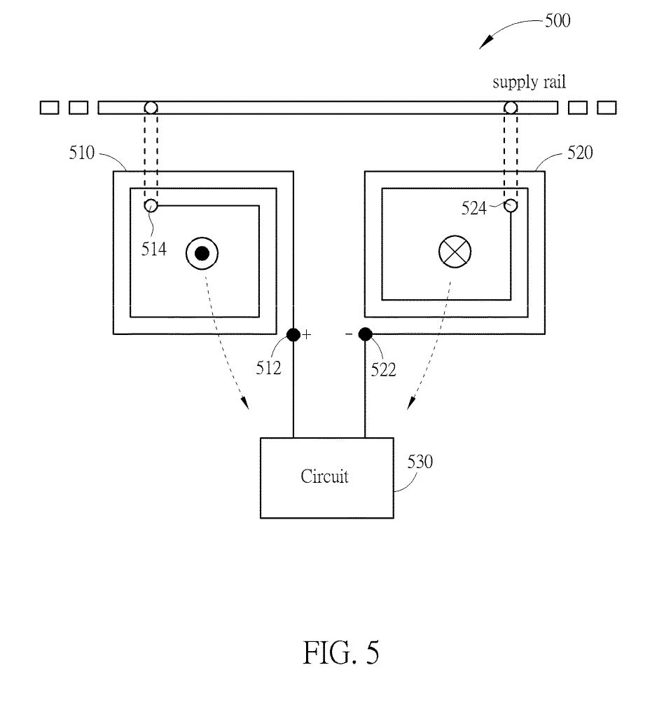

Please refer to FIG. 5. FIG. 5 is a simplified diagram of a composite inductor structure 500 in accordance with a third embodiment of the present invention, wherein the composite inductor structure 500 can be applied to an IC. As shown in FIG. 5, the composite inductor structure 500 comprises: a first spiral inductor 510 and a second spiral inductor 520, wherein the first spiral inductor 510 and the second spiral inductor 520 are disposed on a same layer. The first spiral inductor 510 has three loops and generates a first electromagnetic field, wherein mutual coupling between the loops of the first spiral inductor 510 is well exploited in a smaller area in comparison with the prior art shown in FIG. 1, and an outermost loop of the first spiral inductor 510 has a first end point 512, and an innermost loop of the first spiral inductor 510 has a second end point 514. The second spiral inductor 520 is arranged to be adjacent to the first spiral inductor 510, and has three loops and generates a second electromagnetic field, wherein mutual coupling between the loops of the second spiral inductor 520 is also well exploited in a smaller area in comparison with the prior art shown in FIG. 1, and an outermost loop of the second spiral inductor 520 has a third end point 522, and an innermost loop of the second spiral inductor 520 has a fourth end point 524. The second spiral inductor 520 is rotated by 90 degree with respect to an orientation of the first spiral inductor 510, and the first electromagnetic field and the second electromagnetic field are oppositely directed. In addition, the first spiral inductor 510 and the second spiral inductor 520 are the same spiral inductors if second spiral inductor 520 is rotated by 0 degree or 560 degree with respect to an orientation of the first spiral inductor 510.

The first spiral inductor 510 and the second spiral inductor 520 have an equal and balance lead length when the first spiral inductor 510 and the second spiral inductor 520 are coupled to a circuit 530, wherein the first end point 512 of the first spiral inductor 510 and the third endpoint 522 of the second spiral inductor 520 are coupled to the circuit 530. The first electromagnetic field and the second electromagnetic field are equal and opposite magnetic fields for the circuit 530, and thus the composite inductor structure 500 has a lower parasitic coupling to the circuit 530 (i.e. other components) in comparison with the prior art shown in FIG. 1. In addition, the second end point 514 and the fourth end point 524 are coupled to a supply rail, and thus the composite inductor structure 500 has a shorter and balance inter-connection in comparison with the prior art shown in FIG. 2a and FIG. 2b. Please note that the above embodiment is only for an illustrative purpose and are not meant to be a limitation of the present invention. For example, the number of loops of the first spiral inductor 510 and the second spiral inductor 520 can be changed according to different design requirements, or the second spiral inductor 520 can be rotated by 180 degree with respect to an orientation of the first spiral inductor 510 according to different design requirements. In addition, the shape of the first spiral inductor 510 and the second spiral inductor 520 also can be changed (for example, circle or other polygon types) according to different design requirements.

Briefly summarized, the composite inductor structure disclosed by the present invention has lower parasitic coupling and well exploited mutual coupling in a smaller area, and a shorter and balance inter-connection, and an equal and balance lead length.

Those skilled in the art will readily observe that numerous modifications and alterations of the device and method may be made while retaining the teachings of the invention. Accordingly, the above disclosure should be construed as limited only by the metes and bounds of the append pointed claims.

What is claimed is:

1. A composite inductor structure, comprising:
a first spiral inductor, having a plurality of loops and generating a first electromagnetic field, wherein an outermost loop of the first spiral inductor has a first endpoint, and an innermost loop of the first spiral inductor has a second end point; and
a second spiral inductor, arranged to be adjacent to the first spiral inductor, having a plurality of loops and generating a second electromagnetic field, wherein an outermost loop of the second spiral inductor has a third end point, and an innermost loop of the second spiral inductor has a fourth end point, and the second spiral inductor is rotated by a specific degree with respect to an orientation of the first spiral inductor, and the first electromagnetic field and the second electromagnetic field are oppositely directed.

2. The composite inductor structure of claim 1, wherein the specific degree is 90 degree.

3. The composite inductor structure of claim 1, wherein the first spiral inductor and the second spiral inductor have an equal and balance lead length when the first spiral inductor and the second spiral inductor are coupled to a circuit.

4. The composite inductor structure of claim 3, wherein the first end point and the third end point are coupled to the circuit.

5. The composite inductor structure of claim 3, wherein the first electromagnetic field and the second electromagnetic field are equal and opposite magnetic fields for the circuit.

6. The composite inductor structure of claim 1, wherein an inter-connection of the first spiral inductor and the second spiral inductor is connected between the second end point and the fourth end point.

7. The composite inductor structure of claim 1, wherein the second end point is coupled to a first supply rail and the fourth end point is coupled to a second supply rail.

8. The composite inductor structure of claim 1, wherein the second end point and the fourth end point are coupled to a supply rail.

9. The composite inductor structure of claim 1, applied to an integrated circuit (IC)
